(19) United States
(12) Patent Application Publication
(10) Pub. No.: US 2022/0122124 A1
(43) Pub. Date: Apr. 21, 2022

(54) METHOD OF RECOMMENDING CONTENT, ELECTRONIC DEVICE, AND COMPUTER-READABLE STORAGE MEDIUM

(71) Applicant: Beijing Baidu Netcom Science Technology Co., Ltd., Beijing (CN)

(72) Inventors: Yafei LI, Beijing (CN); Shichen SHAO, Beijing (CN); Shouxun WANG, Beijing (CN)

(21) Appl. No.: 17/564,364

(22) Filed: Dec. 29, 2021

(30) Foreign Application Priority Data
Mar. 12, 2021 (CN) 202110268705.1

(51) Int. Cl. G06Q 30/02

(52) U.S. Cl. CPC G06Q 30/0254; G06Q 30/0256

(57) ABSTRACT

A method of recommending content, an electronic device, and a computer-readable storage medium, relate to a field of artificial intelligence, especially a field of intelligent recommendation. The method includes: determining a target content from candidate contents based on a query of a user, the candidate contents being determined based on a content-related user attention; determining an estimated user cost for acquiring the target content, based on a historical click-through rate for the target content, a historical conversion rate for the target content, and a historical user cost for acquiring the target content; determining one or more recommendation scores for the target content based on the estimated user cost; and recommending a content to the user based on the one or more recommendation scores.

### CROSS REFERENCE TO RELATED APPLICATION(S)

This application claims priority to Chinese Patent Application No. 202110268705.1, filed on Mar. 12, 2021, the entire contents of which are incorporated herein in their entireties by reference.

### TECHNICAL FIELD

This application relates to the field of artificial intelligence technology, and more specifically to a method of recommending content, an electronic device, and a computer-readable storage medium.

### BACKGROUND

With the gradual entry into the information age, the world today is in an environment of an information explosion, while facing a severe information overload problem. On major e-commerce, video playback platforms, and audio playback platforms, users create massive amounts of content every day, or receive massive amounts of recommended content. Information redundancy brings users huge knowledge anxiety and selection difficulties. For users, it is expected that content may be acquired more accurately and efficiently. For content creators, it is expected that the content created by them may be conveyed to more users in need with low cost and high efficiency.

### SUMMARY

A method of recommending content, an electronic device, and a computer-readable storage medium are provided according to the embodiments of the present disclosure.

According to a first aspect of the embodiments of the present disclosure, a method of recommending content is provided, including: determining a target content from candidate contents based on a query of a user, the candidate contents being determined based on a content-related user attention; determining an estimated user cost for acquiring the target content, based on a historical click-through rate for the target content, a historical conversion rate for the target content, and a historical user cost for acquiring the target content; determining one or more recommendation scores for the target content based on the estimated user cost; and recommending a content to the user based on the one or more recommendation scores.

According to a second aspect of the embodiments of the present disclosure, an electronic device is provided, including: one or more processors; and a storage device storing one or more programs, and the one or more programs, when executed by the one or more processors, cause the one or more processors to implement the method according to the first aspect of the embodiments of the present disclosure.

According to a third aspect of the embodiments of the present disclosure, a non-transitory computer-readable storage medium having computer instructions therein is provided, wherein the computer instructions are configured to cause a computer to implement the method according to the first aspect of the embodiments of the present disclosure.

It should be understood that the content described in this part is not intended to identify critical or important features of the embodiments of the present disclosure, and it is not intended to limit the scope of the present disclosure. Other features of the present disclosure may become easily understood according to the following description.

### BRIEF DESCRIPTION OF THE DRAWINGS

With reference to the accompanying drawings and the following detailed description, the above and other features, advantages, and aspects of the embodiments of the present disclosure will become more apparent. In the drawings, the same or similar reference signs indicate the same or similar elements. The accompanying drawings are used to better understand the solution and do not constitute a limitation to the present disclosure, in which:

FIG. 1 shows a schematic diagram of an example environment in which some embodiments of the present disclosure may be implemented;

FIG. 2 shows a flowchart of an example of recommending content according to some embodiments of the present disclosure;

FIG. 3 shows a flowchart of an example of determining an estimated user cost according to the embodiments of the present disclosure;

FIG. 4 shows a schematic block diagram of an apparatus of recommending content according to the embodiments of the present disclosure; and

FIG. 5 shows a block diagram of a computing device capable of implementing some embodiments of the present disclosure.

### DETAILED DESCRIPTION OF EMBODIMENTS

Hereinafter, the embodiments of the present disclosure will be described in more detail with reference to the accompanying drawings. Although some embodiments of the present disclosure are shown in the accompanying drawings, it should be understood that the present disclosure may be implemented in various forms and should not be construed as being limited to the embodiments set forth herein. On the contrary, these embodiments are provided for a more thorough and complete understanding of the present disclosure. It should be understood that the accompanying drawings and embodiments of the present disclosure are only used for exemplary purposes, and are not used to limit the protection scope of the present disclosure.

In the description of the embodiments of the present disclosure, the term “including” and similar terms should be understood as open-ended inclusion, that is, “including but not limited to”. The term “based on” should be understood as “at least partially based on”. The term “an embodiment”, “one embodiment” or “the embodiment” should be understood as “at least one embodiment”. The terms “first”, “second”, etc. may refer to different objects or the same object. Other explicit and implicit definitions may also be included below.

The term “feature” refers to a representation of messages, expressions and actions through a low-dimensional vector. A nature of the feature vector causes objects corresponding to vectors with similar distances to have similar meanings. Using the concept of “feature” may encode objects with low-dimensional vectors and retain the characteristics of their meanings, which is very suitable for deep learning.

As mentioned above, contents created by content creators should be recommended to users effectively. In an existing solution, the content creators use manual configuration to release and promote the contents and make relevant pushes after guessing user needs. A user needs to search for multiple times and compare the contents to determine a desired content. A disadvantage of the existing solution lies in a high cost and low efficiency of content release and recommendation through the manual configuration. In addition, the content creators lack user understanding, fail to understand the user needs, and fail to effectively perform a targeted release. As a result, it is impossible to recommend suitable content to target users accurately.

Example embodiments of the present disclosure propose a solution of recommending content. In the solution, a target content is determined from candidate contents with a high degree of attention according to a query of a user first. Then, an estimated user cost for a user to acquire the target content is determined, based on a historical click-through rate for the target content, a historical conversion rate for the target content, and a historical user cost for the user to acquire the target content. Next, one or more recommendation scores for the target content are determined based on the estimated user cost. Finally, a content is recommended to the user according to the one or more recommendation scores described above. Thus, the estimated user cost needed for the content may be determined intelligently and accurately by using the historical data related to the content. Further, the content may be recommended to the user efficiently and accurately according to the estimated user cost determined above.

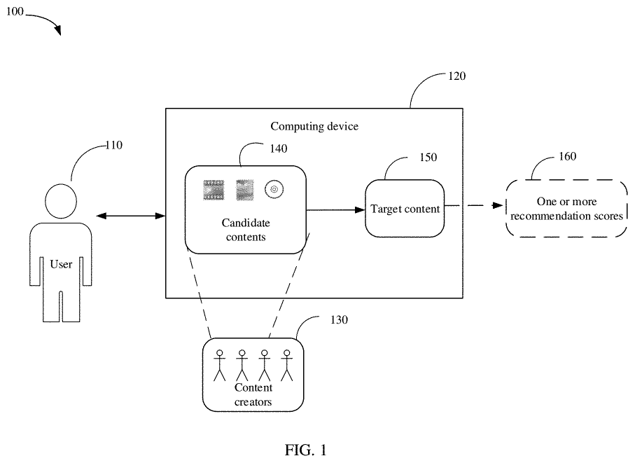

FIG. 1 shows a schematic diagram of an example environment 100 in which some embodiments of the present disclosure may be implemented. As shown in FIG. 1, the example environment 100 may include a user 110, a computing device 120, content creators 130, candidate contents 140, a target content 150, and one or more recommendation scores 160. Although only one user is shown, the number of the user is only exemplary. Those skilled in the art may understand that a plurality of users may also exist at the same time. The present disclosure is not limited to this.

The “user” described in the present disclosure refers to a party that needs or subscribes to a service, and the “content creator” described in the present disclosure refers to an individual, tool, or other entity that provides a service or assists in providing a service. In addition, the “user” and the “content creator” described in the present disclosure are interchangeable, that is, the “user” may create a content for release, or may recommend a content to the “content creator”, and the present disclosure is not limited to this.

The user 110 and the content creators 130 may be users of various types of applications, the applications may be an application including a recommendation system, including but not limited to knowledge document applications, shopping applications, short video applications, music applications, dating applications, news applications, post bar applications, cloud storage applications, search applications, etc. The present disclosure is not limited to this.

The candidate content 140 and the target content 150 may be knowledge documents, commodities, live broadcast rooms, short videos, pictures, music, character information, etc. in the above-mentioned application including the recommendation system. In some embodiments, the candidate content 140 and the target content 150 may be created by the content creator 130. The user 110 receives a recommended video, picture, text, voice, or a combination thereof related to the target content 150 in the above-mentioned application. For example, after entering the news application, the user receives a cover picture, news headline text information or video information of recommended news on a display interface.

In some embodiments, the computing device 120 may determine the target content 150 based on an attention of the candidate content 140. In some embodiments, the computing device 120 may determine whether to recommend the target content 150 to the user 110 based on user historical selection data for the target content 150. This will be described in detail below.

The computing device 120 may match the target user 110 entering the application with the target content 150 based on the above-mentioned features, thereby recommending the target content 150 to the target user 110 who needs the target content 150.

Although the computing device 120 is shown as including the candidate content 140 and the target content 150, the computing device 120 may also be an entity other than the candidate content 140 and the target content 150. The computing device 120 may be any device with computing capabilities. As a non-limiting example, the computing device 120 may be any type of fixed computing device, mobile computing device, or portable computing device, including but not limited to desktop computers, laptop computers, notebook computers, netbook computers, tablet computers, multimedia computers, mobile phones, etc.; all or part of components of the computing device 120 may be distributed in the cloud. The computing device 120 at least includes a processor, a memory, and other components usually present in a general-purpose computer, so as to implement functions such as calculation, storage, communication, and control.

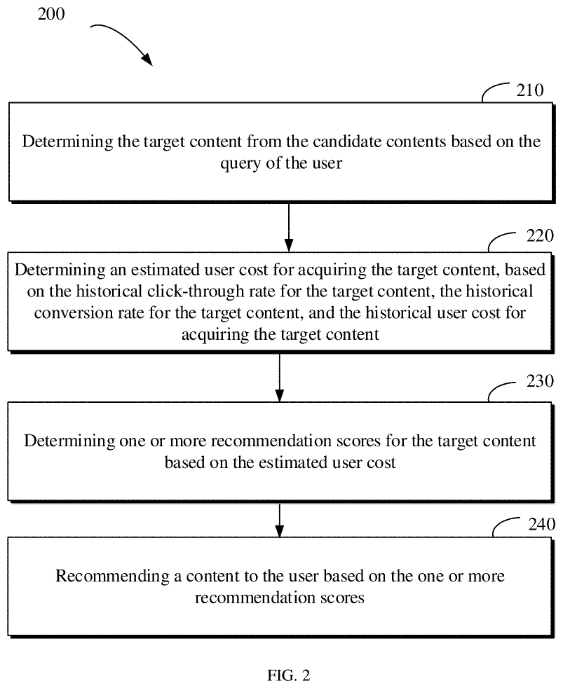

The detailed object recommending process will be further described below with reference to FIGS. 2 to 5. FIG. 2 shows a flowchart of a process 200 of recommending content according to some embodiments of the present disclosure. The process 200 may be implemented by the computing device 120 in FIG. 1. For ease of description, the process 200 will be described with reference to FIG. 1.

In block 210 of FIG. 2, the computing device 120 determines the target content 150 from the candidate contents 140 based on a query of the user 110, and the candidate contents 140 are determined based on a content-related user attention. For example, the computing device 120 may determine the target content 150 for the query of the user according to a correlation between the query of the user and the content.

In an example, the computing device 120 may first determine the candidate contents to form a content candidate pool. The candidate contents are determined according to the content-related user attention. The attention may also refer to a demand of the user for the content. In some embodiments, the attention may be determined based on a historical click-through rate of the user for the target content, a historical conversion rate for the target content, and a historical user cost for acquiring the content. The click-through rate may refer to a probability that a user clicks on the content after entering the user interface presenting the content. The conversion rate may refer to a probability that the user further selects the content for viewing, using, or using points for redemption after clicking the content. The user cost may indicate the points or a specific in-app item, and so on, consumed by the user to select the content. For example, the attention may be determined by a following Formula (1):

Attention=Historical click-through rate*Historical conversion rate*Historical user cost Formula (1)

Then, the computing device 120 may sort the attention of a plurality of contents, so as to determine contents with higher attention (for example, within a threshold sorting rank) as the candidate contents.

Alternatively, in some embodiments, when the content is in a cold start phase, for example, the content has just been released into a certain application, and there is no historical data of the content at this time. Then, the computing device may determine a similarity of the content through historical data of other content (for example, whose matching degree with this content is greater than a threshold value) that is similar to the content. By using the historical data to determine the candidate contents, high-quality contents may be selected to form the content candidate pool. On the one hand, this reduces a scope of a subsequent recommendation and reduces a computing power burden on the computing device. On the other hand, the high-quality contents tend to be chosen by the user, thereby increasing a content distribution rate.

After the candidate contents are determined, the computing device 120 may determine the target content 150 according to a search keyword of the user 110. For example, the computing device 120 may first determine a first feature for characterizing a language structure of the query of the user 110. Next, the computing device 120 may determine a second feature for characterizing a language structure of a candidate content. And finally, if it is determined that a matching degree between the first feature and the second feature is greater than a second threshold, the candidate content is determined as the target content.

In some embodiments, the computing device 120 may acquire a title of the candidate content in the content candidate pool, and then determine whether to determine the candidate content 140 as the target content 150 based on a matching degree between a keyword in the title and the keyword in the query of the user 110. Alternatively, in some embodiments, the computing device 120 may also use a suitable algorithm to identify and summarize the texts and pictures in the content, and then determine the matching degree with the query of the user. The matching degree there between may be calculated by any suitable algorithm, and the present disclosure is not limited to this. By combining the high-quality candidate contents with the user needs to further select the target content, it is possible to lay a foundation for a subsequent accurate content recommendation.

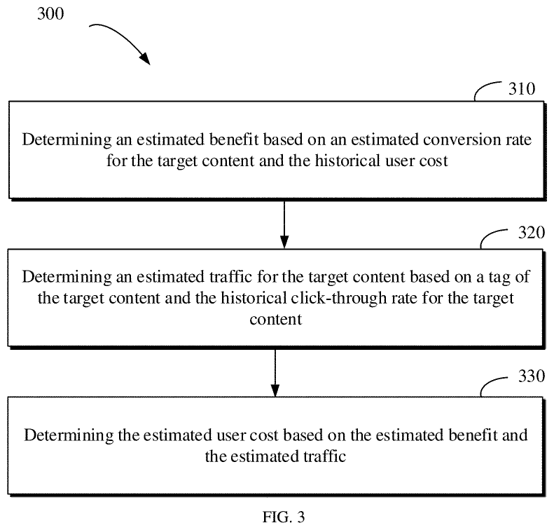

In block 220 of FIG. 2, the computing device 120 determines an estimated user cost for acquiring the target content, based on the historical click-through rate for the target content, the historical conversion rate for the target content, and the historical user cost for acquiring the target content. For example, the computing device 120 may determine the estimated user cost consumed by the user to acquire the content, based on the historical data of the content. This process will be described in detail with reference to FIG. 3.

FIG. 3 shows a flowchart of a process 300 of determining an estimated user cost according to the embodiments of the present disclosure. In block 310 of FIG. 3, the computing device 120 determines an estimated benefit based on an estimated conversion rate for the target content 150 and the historical user cost for the target content 150. For example, the computing device 120 may determine a historical benefit of the target content 150 based on the historical data of the target content 150. The historical user cost may represent the points consumed by the user to acquire the target content, and the historical benefit may represent points that the content creator 130 may acquire through the target content 150. For example, the estimated benefit may be calculated by a following Formula (2):

Estimated benefit=Conversion rate*User cost*Predetermined ratio Formula (2)

The predetermined ratio may be a ratio between the points actually acquired by the content creator 130 and the points consumed by the user to acquire the target content. The ratio is usually between 0 and 1, but may also be greater than 1, the present disclosure is not limited to this. The estimated benefit may also be calculated by other suitable algorithms and formulas, and the present disclosure is not limited to this.

In block 320 of FIG. 3, the computing device 120 determines an estimated traffic for the target content based on a tag of the target content 150 and the historical click-through rate for the target content 150. For example, the computing device 120 may determine the estimated traffic for the target content 150 by comprehensively considering the tag of the target content 150 and the historical click-through rate for the target content 150. The tag of the target content 150 may be a tag representing a feature of the target content, for example, the tag may be a classification of the target content, such as music, travel, education, and so on. The tag may also be a specific content described by the target content 150, such as knowledge point A, movie B, and so on. The computing device 120 may determine a suitable tag for the target content 150 through a suitable technology. A target content may have a plurality of different tags. It may be understood that different tags have different popularities in different periods, and probabilities of being queried by the user 110 are also different. In some embodiments, the estimated traffic for the target content 150 may be determined by a following Formula (3):

Estimated traffic=Click-through rate*Tag Formula (3)

By comprehensively considering the popularity of the tag of the target content 150 and the historical click-through rate for the target content 150, the estimated traffic for the target content may be accurately determined.

In block 330 of FIG. 3, the computing device 120 determines the estimated user cost based on the estimated benefit and the estimated traffic. In some embodiments, the computing device 120 may determine the estimated user cost based on the estimated benefit and the estimated traffic determined above. For example, the computing device 120 may determine the estimated user cost through a following Formula (4):

Estimated user cost=Estimated benefit/Estimated traffic Formula (4)

By comprehensively considering the estimated benefit and the estimated traffic, it may be ensured that the target content 150 may have enough traffic while ensuring its benefit, and user experience of the content creator who creates the target content may be improved.

In block 230 of FIG. 2, the computing device 120 determines one or more recommendation scores 160 for the target content 150 based on the estimated user cost. For example, the computing device 120 determines one or more recommendation scores 160 for the target content 150 based on the acquired historical data and the determined estimated user cost described above.

In some embodiments, the computing device 120 may determine a first recommendation score for the target content based on an estimated click-through rate and the estimated user cost. Then, a second recommendation score for the target content may be determined based on an estimated conversion rate, the historical user cost, and a tag of the target content. For example, the computing device determines the first recommendation score through a following Formula (5):

First recommendation score=Click-through rate*Estimated user cost Formula (5)

The first recommendation score may represent a cost needed to present or release the content, that is, a relevant benefit that may be acquired by the application or platform. The computing device determines the second recommendation score through a following Formula (6):

Second recommendation score=Conversion rate*Historical user cost/Tag Formula (6)

The second recommendation score may represent a total user cost, such as points consumed by the user to acquire the target content. By comprehensively considering different types of recommendation scores, it is possible to further accurately score the target content that matches the user needs, so as to recommend content more reasonably. According to different scenarios, there may also be other types of recommendation scores, which are not limited in the present disclosure.

In block 240 of FIG. 2, the computing device 120 recommends a content to the user based on the one or more recommendation scores 160. For example, the computing device 120 may determine a total recommendation score through the determined recommendation scores mentioned above, and then recommend the content to the user 110 according to the total recommendation score.

In some embodiments, the computing device 120 may determine a sum of the first recommendation score and the second recommendation score as the total recommendation score. Then, total recommendation scores are ranked, and a target content 150 above a predetermined place in the ranking is recommended to the user.

Alternatively, in some embodiments, the computing device 120 may determine a weight of the first recommendation score and a weight of the second recommendation score. Then, the total recommendation score is determined as a recommendation basis according to the weights.

According to the embodiments of the present disclosure, the historical data may be used to determine the candidate contents, and the high-quality contents may be selected to form the content candidate pool, which reduces the scope of the subsequent recommendation and reduces the computing power burden on the computing device. Further, through the matching between the high-quality candidate contents and the query of the user, the target content may be accurately determined. Finally, the target content is further scored to determine the content to be recommended. As a result, it is possible to improve the user's acquiring efficiency to the content, reduce a burden for the content creators to release the contents, and increase the content distribution rate.

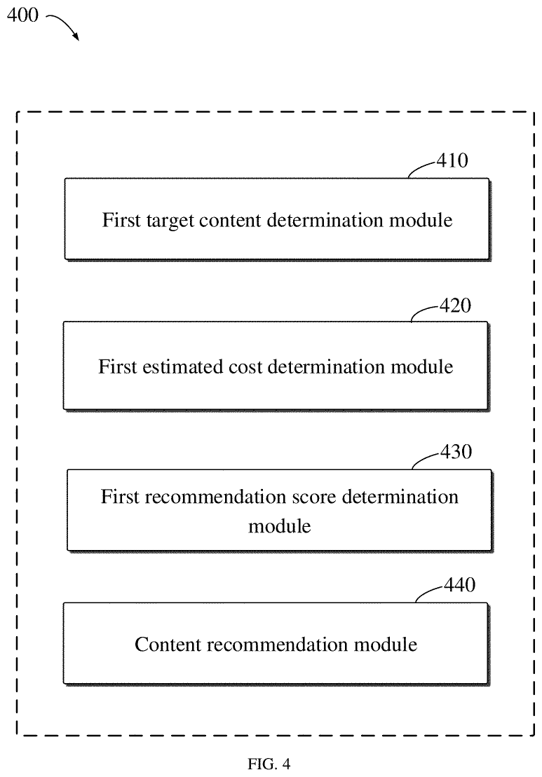

FIG. 4 shows a schematic block diagram of an apparatus 400 of recommending content according to the embodiments of the present disclosure. As shown in FIG. 4, the apparatus 400 includes: a first target content determination module 410 used to determine a target content from candidate contents based on a query of a user, the candidate contents being determined based on a content-related user attention; a first estimated cost determination module 420 used to determine an estimated user cost for acquiring the target content, based on a historical click-through rate for the target content, a historical conversion rate for the target content, and a historical user cost for acquiring the target content; a first recommendation score determination module 430 used to determine one or more recommendation scores for the target content based on the estimated user cost; and a content recommendation module 440 used to recommend a content to the user based on the one or more recommendation scores.

In some embodiments, the first estimated cost determination module 420 may include: a benefit determination module used to determine an estimated benefit based on an estimated conversion rate for the target content and the historical user cost; a traffic determination module used to determine an estimated traffic for the target content based on a tag of the target content and the historical click-through rate for the target content; and a second estimated cost determination module used to determine the estimated user cost based on the estimated benefit and the estimated traffic.

In some embodiments, the first recommendation score determination module 430 may include: a second recommendation score determination module used to determine a first recommendation score for the target content based on an estimated click-through rate and the estimated user cost; and a third recommendation score determination module used to determine a second recommendation score for the target content based on an estimated conversion rate, the historical user cost, and a tag of the target content.

In some embodiments, the content-related user attention is determined based on a historical click-through rate for a content, a historical conversion rate for the content, and a historical user cost for acquiring the content.

In some embodiments, the first target content determination module 410 may include: a first feature determination module used to determine a first feature for characterizing a language structure of the query; a second feature determination module used to determine a second feature for characterizing a language structure of a candidate content; and a second target content determination module used to determine the candidate content as the target content if it is determined that a matching degree between the first feature and the second feature being greater than a second threshold.

It should be noted that the historical user cost of the user and the content-related user attention of the user in the present disclosure are not the historical user cost and the content-related user attention for a specific user, and cannot reflect the personal information of a specific user.

It should be noted that the acquisition, collection, storage, use, processing, transmission, provision and disclosure of the user's personal information involved in the technical scheme of the present disclosure comply with the provisions of relevant laws and regulations and do not violate public order and good customs.

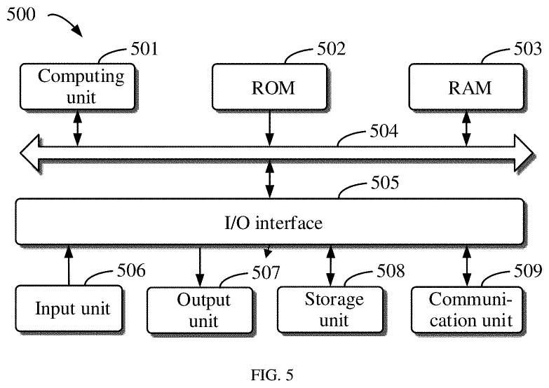

FIG. 5 shows a block diagram of an electronic device 500 capable of implementing some embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smart phone, a wearable device, and other similar computing apparatuses. The components as illustrated herein, and connections, relationships, and functions thereof are merely examples, and are not intended to limit the implementation of the present disclosure described and/or required herein.

As shown in FIG. 5, the electronic device 500 includes a computing unit 501, which may perform various appropriate actions and processing based on a computer program stored in a read-only memory (ROM) 502 or a computer program loaded from a storage unit 508 into a random access memory (RAM) 503. Various programs and data required for the operation of the electronic device 500 may be stored in the RAM 503. The computing unit 501, the ROM 502 and the RAM 503 are connected to each other through a bus 504. An input/output (I/O) interface 505 is also connected to the bus 504.

Various components in the electronic device 500, including an input unit 506 such as a keyboard, a mouse, etc., an output unit 507 such as various types of displays, speakers, etc., a storage unit 508 such as a magnetic disk, an optical disk, etc., and a communication unit 509 such as a network card, a modem, a wireless communication transceiver, etc., are connected to the I/O interface 505. The communication unit 509 allows the electronic device 500 to exchange information/data with other devices through a computer network such as the Internet and/or various telecommunication networks.

The computing unit 501 may be various general-purpose and/or special-purpose processing components with processing and computing capabilities. Some examples of the computing unit 501 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 501 may perform the various methods and processes described above, such as the process 200 and the process 300. For example, in some embodiments, the process 200 and the process 300 may be implemented as a computer software program that is tangibly contained on a machine-readable medium, such as the storage unit 508. In some embodiments, part or all of a computer program may be loaded and/or installed on the electronic device 500 via the ROM 502 and/or the communication unit 509. When the computer program is loaded into the RAM 503 and executed by the computing unit 501, one or more steps of the process 200 and the process 300 described above may be performed. Alternatively, in other embodiments, the computing unit 501 may be configured to perform the process 200 and the process 300 in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input apparatus and the at least one output apparatus, and may transmit the data and instructions to the storage system, the at least one input apparatus, and the at least one output apparatus.

Program codes for implementing the method of the present disclosure may be written in any combination of one or more programming languages. These program codes may be provided to a processor or a controller of a general-purpose computer, a special-purpose computer, or other programmable data processing apparatuses, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or server.

In the context of the present disclosure, the machine readable medium may be a tangible medium that may contain or store programs for use by or in combination with an instruction execution system, device or apparatus. The machine readable medium may be a machine-readable signal medium or a machine readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with the user, the systems and technologies described here may be implemented on a computer including a display apparatus (for example, a CRT (cathode ray tube) or LCD (liquid crystal display) monitor) for displaying information to the user, and a keyboard and a pointing apparatus (for example, a mouse or a trackball) through which the user may provide the input to the computer. Other types of apparatuses may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, also referred to as a cloud computing server or a cloud host, which is a host product in the cloud computing service system to solve shortcomings of difficult management and weak business scalability in conventional physical host and VPS (Virtual Private Server) service. The server may further be a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of recommending content, comprising:
determining a target content from candidate contents based on a query of a user, wherein the candidate contents are determined based on a content-related user attention;
determining an estimated user cost for acquiring the target content, based on a historical click-through rate for the target content, a historical conversion rate for the target content, and a historical user cost for acquiring the target content;
determining one or more recommendation scores for the target content based on the estimated user cost; and
recommending a content to the user based on the one or more recommendation scores.

2. The method according to claim 1, wherein the determining an estimated user cost for acquiring the target content, based on a historical click-through rate for the target content, a historical conversion rate for the target content, and a historical user cost for acquiring the target content comprises:
determining an estimated benefit based on an estimated conversion rate for the target content and the historical user cost;
determining an estimated traffic for the target content based on a tag of the target content and the historical click-through rate for the target content; and
determining the estimated user cost based on the estimated benefit and the estimated traffic.

3. The method according to claim 1, wherein the determining one or more recommendation scores for the target content based on the estimated user cost comprises:
determining a first recommendation score for the target content based on an estimated click-through rate and the estimated user cost; and
determining a second recommendation score for the target content based on an estimated conversion rate, the historical user cost, and a tag of the target content.

4. The method according to claim 1, wherein the content-related user attention is determined based on a historical click-through rate for a content, a historical conversion rate for the content, and a historical user cost for acquiring the content.

5. The method according to claim 1, wherein the determining a target content from candidate contents based on a query of a user comprises:
determining a first feature for characterizing a language structure of the query;
determining a second feature for characterizing a language structure of a candidate content; and
determining the candidate content as the target content in response to determining that a matching degree between the first feature and the second feature being greater than a second threshold.

6. The method according to claim 1, wherein the determining a target content from candidate contents based on a query of a user comprises:
determining a keyword in a title of a candidate content;
determining a keyword in the query of the user;
determining the candidate content as the target content based on a matching degree between the keyword in the title of the candidate content and the keyword in the query of the user.

7. The method according to claim 3, further comprising:
determining a sum of the first recommendation score and the second recommendation score as a total recommendation score.

8. The method according to claim 3, further comprising:
determining a weight of the first recommendation score and a weight of the second recommendation score; and
determining a total recommendation score according to the weight of the first recommendation score and the weight of the second recommendation score.

9. The method according to claim 7, the recommending a content to the user based on the one or more recommendation scores comprising:
ranking a plurality of total recommendation scores for a plurality of target contents; and
recommending to the user a target content which is above a predetermined place in the ranking of the plurality of target contents.

10. The method according to claim 8, the recommending a content to the user based on the one or more recommendation scores comprising:
ranking a plurality of total recommendation scores for a plurality of target contents;
recommending to the user a target content which is above a predetermined place in the ranking of the plurality of target contents.

11. An electronic device, comprising:
at least one processor; and
a memory communicatively connected to the at least one processor,
wherein the memory stores instructions executable by the at least one processor, and the instructions, when executed by the at least one processor, cause the at least one processor to:
determine a target content from candidate contents based on a query of a user, wherein the candidate contents are determined based on a content-related user attention;
determine an estimated user cost for acquiring the target content, based on a historical click-through rate for the target content, a historical conversion rate for the target content, and a historical user cost for acquiring the target content;
determine one or more recommendation scores for the target content based on the estimated user cost; and
recommend a content to the user based on the one or more recommendation scores.

12. The electronic device according to claim 11, wherein the at least one processor is further configured to:
determine an estimated benefit based on an estimated conversion rate for the target content and the historical user cost;
determine an estimated traffic for the target content based on a tag of the target content and the historical click-through rate for the target content; and
determine the estimated user cost based on the estimated benefit and the estimated traffic.

13. The electronic device according to claim 11, wherein the at least one processor is further configured to:
determine a first recommendation score for the target content based on an estimated click-through rate and the estimated user cost; and
determine a second recommendation score for the target content based on an estimated conversion rate, the historical user cost, and a tag of the target content.

14. The electronic device according to claim 11, wherein the content-related user attention is determined based on a historical click-through rate for a content, a historical conversion rate for the content, and a historical user cost for acquiring the content.

15. The electronic device according to claim 11, wherein the at least one processor is further configured to:
determine a first feature for characterizing a language structure of the query;
determine a second feature for characterizing a language structure of a candidate content; and
determine the candidate content as the target content in response to determining that a matching degree between the first feature and the second feature being greater than a second threshold.

16. A non-transitory computer-readable storage medium having computer instructions therein, wherein the computer instructions are configured to cause a computer to:
determine a target content from candidate contents based on a query of a user, wherein the candidate contents are determined based on a content-related user attention;
determine an estimated user cost for acquiring the target content, based on a historical click-through rate for the target content, a historical conversion rate for the target content, and a historical user cost for acquiring the target content;
determine one or more recommendation scores for the target content based on the estimated user cost; and
recommend a content to the user based on the one or more recommendation scores.

17. The non-transitory computer-readable storage medium according to claim 16, wherein the computer instructions are further configured to cause the computer to:
determine an estimated benefit based on an estimated conversion rate for the target content and the historical user cost;
determine an estimated traffic for the target content based on a tag of the target content and the historical click-through rate for the target content; and
determine the estimated user cost based on the estimated benefit and the estimated traffic.

18. The non-transitory computer-readable storage medium according to claim 16, wherein the computer instructions are further configured to cause the computer to:
determine a first recommendation score for the target content based on an estimated click-through rate and the estimated user cost; and
determine a second recommendation score for the target content based on an estimated conversion rate, the historical user cost, and a tag of the target content.

19. The non-transitory computer-readable storage medium according to claim 16, wherein the content-related user attention is determined based on a historical click-through rate for a content, a historical conversion rate for the content, and a historical user cost for acquiring the content.

20. The non-transitory computer-readable storage medium according to claim 16, wherein the computer instructions are further configured to cause the computer to:
determine a first feature for characterizing a language structure of the query;
determine a second feature for characterizing a language structure of a candidate content; and
determine the candidate content as the target content in response to determining that a matching degree between the first feature and the second feature being greater than a second threshold.
